(19) United States
(12) Patent Application Publication
(10) Pub. No.: US 2025/0005425 A1
(43) Pub. Date: Jan. 2, 2025

(54) CLOUD-ACCESSIBLE QUANTUM SIMULATOR BASED ON PROGRAMMABLE ATOM ARRAYS

(71) Applicant: The Trustees of Columbia University in the City of New York, New York, NY (US)

(72) Inventor: Sebastian Will, New York, NY (US)

(73) Assignee: The Trustees of Columbia University in the City of New York, New York, NY (US)

(21) Appl. No.: 18/393,162

(22) Filed: Dec. 21, 2023

Related U.S. Application Data
(60) Provisional application No. 63/434,613, filed on Dec. 22, 2022.

(51) Int. Cl. G06N 10/80; G06N 10/20; G21K 1/00

(52) U.S. Cl. CPC G06N 10/80; G06N 10/20; G21K 1/006

(57) ABSTRACT

The disclosed subject matter relates to a cloud-accessible quantum simulator based on programmable atom arrays. An example cloud-accessible quantum simulator can include an atomic platform, a laser and photonics system, a timing and control box, a user interface, and quantum algorithms. The disclosed system provides a platform for developing and implementing quantum algorithms in multiple fields.

### CROSS-REFERENCE TO RELATED APPLICATION

This application claims priority to U.S. Provisional Patent Application Ser. No. 63/434,613, filed Dec. 22, 2022, which is hereby incorporated by reference in its entirety.

### GRANT INFORMATION

This invention was made with government support under grant number FA9550-23-1-0404 awarded by the Air Force Office of Scientific Research. The government has certain rights in the invention.

### BACKGROUND

Atoms of the same isotope are identical by nature, highly reproducible in large quantities, and can be prepared, manipulated, and observed with the utmost precision. Two approaches for conducting research on quantum devices with ultracold neutral atoms include quantum gas microscopy and optical tweezer arrays. Optical lattice quantum gas microscopes can rely on mobile atoms and on-site interactions with trapping sites that are generally spaced by half a micrometer. Such microscopes can be used as analog quantum simulators for complex many-body quantum phenomena with relevance in condensed matter physics, nuclear physics, and cosmology.

Atomic tweezer arrays can rely on immobile isolated Rydberg atoms and long-range interactions with trapping sites typically spaced by several micrometers. Such arrays can be used to implement complex spin-Hamiltonians, realizing architectures related to digital quantum computing.

There exists a need for a programmable trapping platform that combines the strength of single atom control of optical tweezer arrays with the possibility of tunnel coupling that is the source of entanglement in quantum gas microscopes.

### SUMMARY

The disclosed subject matter provides a cloud-accessible integrated quantum simulator. According to certain embodiments, an exemplary simulator includes an atomic platform configured to provide a source of atoms, a laser and photonics system configured to cool and trap the atoms, a timing and control box, a user interface configured to control the atomic platform and the laser and photonics system, and quantum algorithms.

In certain embodiments, the atomic platform includes one or more atomic sources, a vacuum chamber, and an imagining system. In certain embodiments, the atomic source includes a high-flux source for strontium atoms. In certain embodiments, the strontium atoms are ⁸⁸Sr or ⁸⁷Sr. In certain embodiments, the atoms in the atomic source have an atomic flux greater than >10⁹ atoms/second. In certain embodiments, the vacuum chamber includes a glass cell with wide optical access.

In certain embodiments, the laser and photonics system includes a holographic metasurface configured to generate an optical tweezer array from the one or more incident laser beam. In certain embodiments, the optical tweezer array is two-dimensional.

In certain embodiments, the vacuum chamber includes a two-stage magneto-optical trap (“MOT”). In certain embodiments, a first stage of the MOT includes a blue 2D MOT having a wavelength of 461 nanometers. In certain embodiments, a second stage of the MOT includes a narrow-line MOT having a wavelength of 689 nanometers.

In certain embodiments, the chip-based photonic sources can be a composite silicon nitride (SiN)-lithium niobate (LN) platform.

In certain embodiments, the atomic platform is configured to collect atoms in an array of traps. In certain embodiments, the array of traps is generated by a holographic metasurface.

In certain embodiments, the laser and photonic system is configured to initialize atoms to a metastable state.

In certain embodiments, the timing and control box comprises a timing system with nanosecond-resolution.

In certain embodiments, the user interface is configured to allow users to interact with and control the simulator.

In certain embodiments, the quantum algorithms are configured to be operated on hardware integrated into the simulator.

In certain embodiments, the user interface is configured to allow users to input the quantum algorithms.

In certain embodiments, the simulator further includes an integrated holographic spatial light modulator (SLM) configured to consume low power to optically manipulate cold atoms.

### BRIEF DESCRIPTION OF THE DRAWINGS

FIG. 1 shows an exemplary stack diagram of a cloud-accessible integrated quantum simulator in an embodiment of the disclosed subject matter.

FIG. 2 shows an exemplary diagram of an atom trapping apparatus according to an embodiment.

FIG. 3 shows a schematic for an optical layout of the experimental setup for trapping and controlling ⁸⁸Sr atoms in a metasurface array according to an embodiment.

FIG. 4 shows a schematic of an integrated chip-based tunable laser system according to an embodiment.

FIG. 5A shows a schematic of a 2D array of monolithic meta-atoms (building blocks of metasurfaces) to realize complete phase amplitude control according to an embodiment.

FIG. 5B shows an exemplary SEM image of an array of bilayer meta-atoms according to an embodiment.

FIG. 5C shows a simulation of a Kagome lattice according to an embodiment.

FIG. 5D shows an exemplary pattern reproducing the locations of US cities (here, an excerpt of Florida) generated by a metasurface according to an embodiment.

FIG. 6 shows software architecture diagram in an embodiment.

FIG. 7A shows a characterization of homebuilt 2D MOT beam source upon cooling of ⁸⁸Sr according to an embodiment.

FIG. 7B shows a fluorescence image after narrow-line cooling (689 nm) according to an embodiment.

FIG. 8A shows a schematic of creating dynamically controllable tweezer arrays with 30×30=900 traps according to an embodiment.

FIG. 8B shows a holographic metasurface with (top) SEM image of a TiO2 metasurface with subwavelength size control units, and (bottom) Metasurface according to an embodiment.

FIG. 9A shows a relevant level diagram for an optical clock transition serving as a long-lived qubit state according to an embodiment.

FIG. 9B shows a phase-gate scheme for different phases according to an embodiment.

FIG. 9C shows an array of dimerized traps using a holographic metasurface according to an embodiment.

FIG. 10A shows a relevant level diagram with states g and r serving as an effective spin-½ system according to an embodiment.

FIG. 10B shows a Kagome trapping array using a holographic metasurface according to an embodiment.

It is to be understood that both the foregoing general description and the following detailed description are exemplary and are intended to provide further explanation of the disclosed subject matter.

### DETAILED DESCRIPTION

The disclosed subject matter provides systems and techniques including programmable atom arrays, which can be used for quantum simulation. The disclosed arrays can be configured to control individual atoms with improved precision and flexibility.

### Definitions

As used herein, the term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, up to 10%, up to 5%, and up to 1% of a given value. Alternatively, e.g., with respect to biological systems or processes, the term can mean within an order of magnitude, within 5-fold, and within 2-fold, of a value.

As used herein, the term “MOT” or “magneto optical traps” refers to a system capable of capturing or trapping atoms, for example by using laser cooling. The MOT system or apparatus can be generally integrated with a spatially-varying magnetic field and laser system, the combination of which allows the atoms to be captured and maintained because the atoms are moving slowly enough at low temperature created by laser cooling to be trapped using the spatially-varying magnetic fields.

As used herein, the term “atomic flux” is a term generally used in the field of quantum physics to refers to the rate at which atoms move through a given area, including a hole or opening, per unit time. Atomic flux can be measured using a spectrometry. Atomic flux can be quantified using the amount of atoms that flow through a unit area in a unit time, for example, but not limited to, atoms per second.

As used herein, the term “Zeeman slower” refers to a device used in atomic physics to cool and slow down an atomic beam by using the Zeeman effect, capable of being used in the fields of atomic clocks, and quantum computing.

As used herein, the term “magic wavelength” refers to a specific wavelength of light that has the unique property of exerting the same force on an atom in different energy states.

In certain embodiments, the disclosed system can be cloud-accessible to a broad user-base (e.g., including computer scientists, data scientists, and educators). The disclosed system provides a platform for developing and implementing quantum algorithms with real-world relevance in materials science, quantum chemistry, and optimization for the synthesis of novel functional materials and substantial energy savings in the chemical industry. The disclosed system combines features of analog quantum simulation and digital quantum computing in the same system.

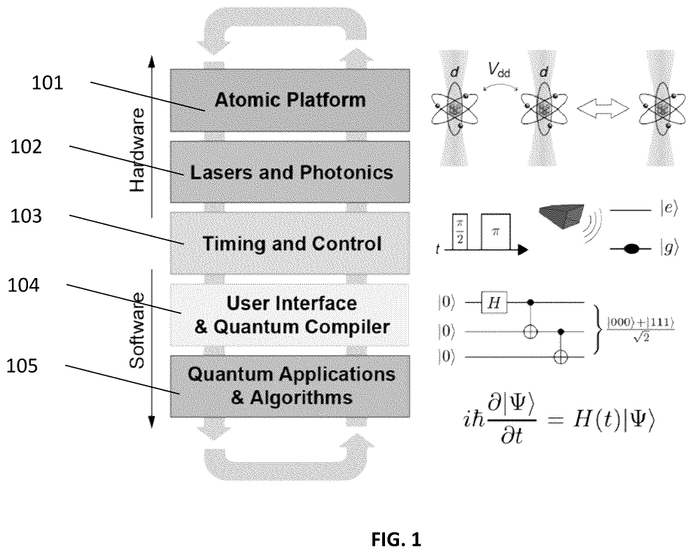

In certain embodiments, the disclosed system can include features of analog quantum simulation and digital quantum computing. Referring to FIG. 1, an example system can include an atomic platform 101, which can be based on neutral strontium atoms in the ground and Rydberg states. In non-limiting embodiments, the disclosed system can include lasers and photonics 102 that can be used for holographic atom traps and compact, chip-based laser systems.

In non-limiting embodiments, the disclosed system can include a timing system and a control system (e.g., including a timing system with nanosecond resolution). In non-limiting embodiments, the disclosed system can include a user interface for secure and easy cloud access.

In non-limiting embodiments, the disclosed system can include quantum Algorithms and Applications for informing the design of hardware to realize a system that can provide a quantum advantage for various applications (e.g., materials research, chemistry, logistics, and finance calculations).

According to embodiments, the disclosed quantum device can be sufficiently large, interconnected, and flexible to perform relevant calculations with quantum advantage over classical hardware. These calculations can include problems in quantum magnetism encoded in spin-Hamiltonians that help to elucidate the physical origins of high-temperature superconductivity. Insights can lead to the synthesis of room-temperature superconductors, circumventing the typical energy transport losses of 20% in the US power grid.

According to embodiments, the disclosed quantum simulation platform can address NP-hard graph theory problems relevant to financial portfolio optimization and the solution of the traveling salesman problem in complex networks. Advances can lead to optimized logistics, save natural resources, reduce humanity's CO₂ footprint, cost, and environmental impact.

In certain embodiments, the disclosed techniques for integration, miniaturization, and standardization for atomic quantum devices can facilitate the construction of atomic quantum devices on a broad scale. For example, the disclosed techniques can support construction of compact atom interferometers or compact atomic clocks and can find application for the navigation of autonomous vehicles or as precision gravimeters for geodesy.

According to embodiment of the disclosed subject matter, the cloud-accessible integrated quantum simulation system can be divided into five areas which span across software and hardware aspects. For example, the five areas can include: atomic platform 101, lasers and photonics 102, timing and control 103, user interface and quantum compiler 104, and quantum applications and algorithms 105. Each of these five areas will now be discussed in greater detail.

### Atomic Platform

According to embodiments, an example atomic platform 101 of the disclosed subject matter can be based on neutral strontium atoms in ground and Rydberg states

In certain embodiments, the disclosed systems can utilize ultracold strontium (Sr) atoms. Sr atoms can be beneficial since they have two valence electrons, which provides Sr atoms a rich level structure that is well suited for efficient laser cooling and optical manipulation. Strontium offers both Strontium offers both fermionic and bosonic isotopes, providing different strengths for different applications—such as SU(N) ground state structure in fermionic ⁸⁷Sr, hyperfine-free ground states in ⁸⁸Sr, and the ultranarrow ¹S₀-³P₀ transition for precision spectroscopy on single atom as well as many-body quantum states. For fermionic ⁸⁷Sr, ¹S₀-³P₀ can be used as a clock transition with an ultranarrow natural linewidth on the ˜mHz level, which comes with exceptional coherence times well above 1 second.

According to embodiments, the disclosed platform can trap both ⁸⁷Sr and ⁸⁸Sr and can be based on a compact vacuum system. For example, vacuum system can have a footprint of approximately 70 cm by 50 cm.

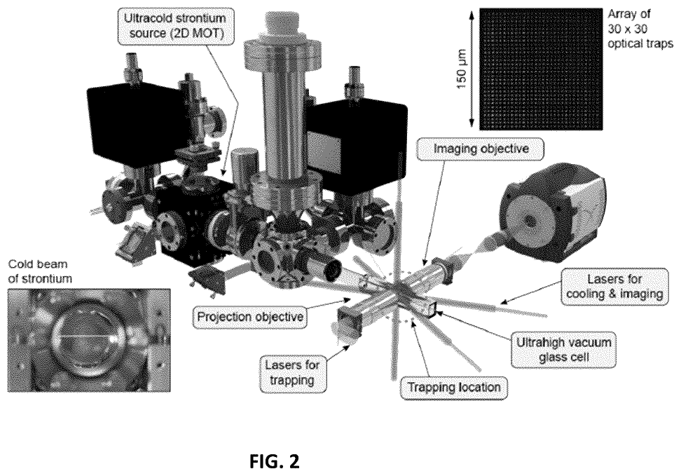

In certain embodiments, the atomic platform 101 can include atomic sources, a vacuum chamber, and an imaging system. According to embodiment, atomic source can include a high-flux source (i.e., greater than 10⁹ atoms/second) for strontium atoms, as shown in FIG. 2. In certain embodiments, atomic source can include effusive dispensers from which atoms can be directly cooled by leveraging the high capture velocity (up to 100 m/s) for laser cooling of Sr on the ¹S₀-¹P₁ transition (461 nm). Atomic sources of the disclosed subject matter can reach an atomic flux of >10⁹ atoms/second, which is comparable to the performance of Zeeman slowers, but at about a quarter of the size and cost.

According to embodiments, vacuum chamber for the quantum simulator can include a glass cell science chamber with wide optical access configured to allow objectives with high numerical aperture (NA>0.5) close to the trapping region for high resolution imaging and the projection of high-quality optical tweezer arrays. In certain embodiments, two objectives can be arranged in close proximity (<1 cm) to the atoms with an NA of ˜0.8 and a field of view of 100 μm. If tweezer traps are spaced approximately 1 μm, 2D arrays with up to 10,000 atoms can be achieved using the disclosed systems. According to embodiments, the “projection” objective can project light patterns at magic wavelength (˜500 nm) generated by a holographic metasurfaces on the atomic cloud.

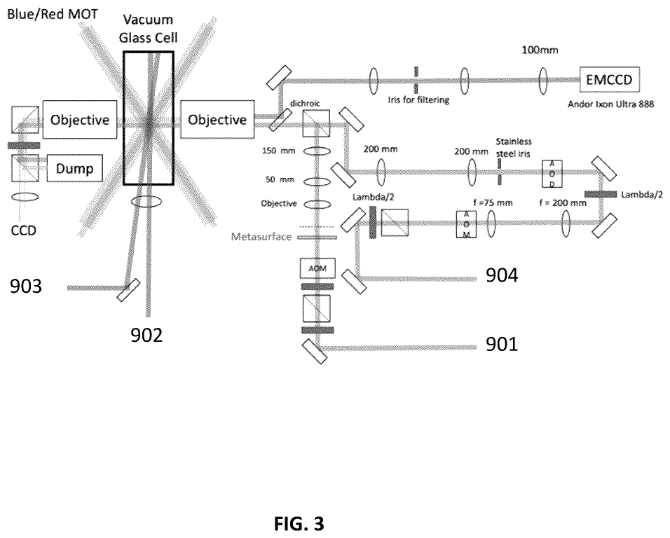

FIG. 3 shows an exemplary optical layout for trapping and controlling ⁸⁸Sr atoms in a metasurface array. For example, exemplary optical layout can include high-power laser 901 at 497 nm, clock laser system 902 at 698 nm, Rydberg excitation system 903, and autoionization laser 904, as described above.

At the magic wavelength of 497 nm, polarization can be about five times larger than at the standard magic wavelength at 813.4 nm. The shorter magic wavelength can allow creating of tighter traps due to the shorter wavelength, thereby allowing arrays with at least 5 times more traps than at 813 nm. The tighter traps can be facilitated by holographic metasurfaces for tweezer array generation, as described below. As a result, power requirements can be reduced by at least 5 times to achieve the same depth per trap. For example, for 497 nm, 2 mW/trap can be sufficient to reach a depth of 2000 recoil energies, which for about 2 Watts of available power will allow scaling to 1000 traps. Using the magic wavelength at 497 nm will allow the generation of larger arrays than demonstrated so far due to the high polarizability of Sr at this wavelength. For example, the number of traps can be increased to more than 1000, which will substantially suppress finite size effects in these simulations.

Nonlimiting exemplary lasers can include a vertical-external-cavity surface-emitting-laser (VECSEL) operating at 994 nm that is frequency doubled. Locked linewidth can be <100 kHz, comparable to a TiSa laser which is typically used for creating of the magic wavelength at 813 nm. The laser can be locked to an existing wavemeter (such as HighFinesse WS-7) through an 8-channel galvo-based multiplexer. Unwanted spectral background (amplified spontaneous emission) laser can be filtered through a volume Bragg grating.

Referring to FIG. 2, optical tweezer arrays with 30×30 traps using crossed acousto-optic deflectors (AODs) can be generated using the disclosed subject matter. More specifically, individual atoms are captured from laser cooled clouds of atoms and trapped in highly focused laser beams or optical tweezers (as described further below). Arrays with large number of optical tweezers enable trapping a large number of atoms (for example, up to 1,000 atoms or more), since each trap is generally occupied by exactly one atom. In certain embodiments, the statistical filling fraction of traps is around 0.5. to achieve unity filling, single-site resolved fluorescence imaging can be used to detect which traps are empty. Thereafter, vacancies can be actively filled by sorting individual atoms into them.

Atomic arrays can serve as powerful quantum registers as a result of unity filling. Specifically, each trapped individual atom can serve as a pristine qubit, because all atoms in the array have exactly the same internal level structure.

According to embodiments, Raman-sideband cooling can be used on the intercombination ¹S₀-¹P₁ (689 nm) to reach a high vibrational ground state population. In certain embodiments, magnetic field coil-system can be used to create sufficiently high fields to open the ¹S₃-³P₀ clock transition in ⁸⁸Sr.

According to embodiment, the rearrangement beam can be used to create defect-free tweezer arrays in 1D, 2D, and 3D, as well as a highly focused beam (e.g., with a spot size from 500 nm-1 μm) from a clock laser 902 at 698 nm for local transfer atoms to the shelving state ³P₀ for the implementation of Rydberg gates. The clock laser 902 can initialize all atoms in the array in the metastable ³P₀ state via a global pi-pulse. The ₃P0 state can serve as an effective ground state for Rydberg quantum simulations of the Ising model. In certain embodiments, clock laser 902 can allow performance of arbitrary state rotations on the optical qubit globally. For example, in dimerized arrays this allows the implementation of phase gates. Finally, clock state rotations can be applied locally in the array by stirring the clock beam to individually tweezer sites using a crossed AOD. To that end, the trapping potential of the tweezer array can be supplemented by an optical standing wave in the propagation direction of the tweezer beams to provide enhanced longitudinal confinement.

According to embodiment, the highly focused clock laser beam 902 can be based on a laser system using a diode laser at 698 nm that is locked to an ultrahigh-finesse optical cavity (finesse around 200,000) made from ultra-low expansion glass. The output power can be >10 mW, linewidth <1 Hz and Allan deviation <10⁻¹⁵/τ^{1/2}. The system can include fiber noise cancellation.

According to embodiments, cooling and trapping scheme can include two-stage laser cooling. For example, not limitation, two-stage laser cooling can include a standard blue 3D magneto-optical trap (MPOT) having a 461 nm and 30 MHz linewidth, followed by a narrow-line MOT having 689 nm and 7.6 MHz linewidth. The ¹S₀-¹P₁ transition of the blue MOT can feature a fast scattering rate of 30 MHz, thereby allowing a high capture velocity of around 100 m/s such that atoms can be captured from the source without the need of a Zeeman slower.

According to embodiments, a two-dimensional (2D) magneto-optical trap (MOT) is directly loaded from the atom jet out of dispensers that are resistively heated. The required magnetic quadrupole field can be created with permanent magnets that do not consume power. As a result, the system can be designed to consume less power than comparable systems. The disclosed atomic source is significantly more compact and simpler than the typical approach based on a Zeeman slower.

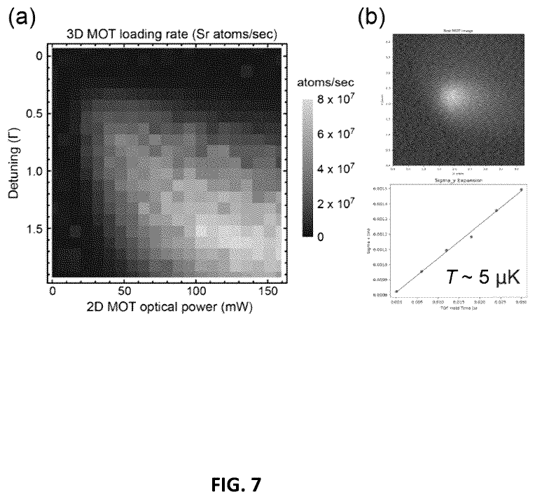

As can be seen in FIG. 7, the disclosed system can load a 3D MOT of ⁸⁸Sr at a rate of around 10⁸ atoms per second (FIG. 7A), which can reach a MOT size of about 107 atoms within around 100 ms, sufficient for loading an atomic tweezer array. Notably, with an increasing of 2D MO optical power and detuning, the 3D MOT loading rate increases, demonstrating an efficient loading for the creation of the atomic tweezer array.

According to embodiments, following the blue MOT, the atoms can be transferred to a narrow-line MOT (as shown in FIG. 7B). The 689 nm laser can be modulated with a 2 MHz bandwidth to capture up to 60% of the atoms from the blue MOT. Thereafter, the modulated bandwidth can be reduced to further cool and compress the cloud. The resulting ⁸⁸Sr in time-of-flight can be observed via fluorescence imaging and detect slow expansion, corresponding to a temperature of around 5 μK (as shown in FIG. 7B).

According to embodiments, repump lasers at 707 nm and 679 nm can recycle population from the dark states ³P₂ and ³P₀. The blue MOT can generate atomic ensembles at around 1 mK that can be further cooled in a second stage to around 1 μK using, for example, a narrow-line MOT operating on the ¹S₀-³P₁ intercombination line, at which atoms can be directly captured in the optical tweezer array. The disclosed subject matter can achieve around 50% atom-loading efficiency after application of a photo-association pulse to remove occupations larger than one atom per tweezer. This multifaceted loading and cooling process showcases the system's capability to prepare and manipulate ultracold atomic ensembles, laying the foundation for various applications, including the creation of precise optical tweezer arrays for quantum information processing.

According to embodiments, a Rydberg excitation system 903 can include a high-power laser system to drive single-photon Rydberg excitation from the ³P₀ state. The system can utilize sum frequency generation to produce about 9 Watts of 634 nm light, which can be doubled via a resonant second-harmonic generation (SHG) stage to produce about 2 Watts of 317 nm. The intrinsic linewidth of the output light is specified to be ˜10 kHz. This can be further narrowed and stabilized using a Pound-Drever-Hall lock to a ULE cavity (finesse˜40,000) via the available 634 nm light. For example, the same ULE cavity used for stabilization of the 689 nm narrow-line cooling light can be purposefully designed to also allow locking of a Rydberg laser.

According to embodiments, Rydberg laser 903 can connect the ³P₀ clock state to ³S₁, which has favorable interaction properties as the van-der-Waals-type Rydberg-Rydberg interactions are nearly isotropic. The typical approach to induce Rydberg excitations is relying on a two-photon excitation protocol. The disclosed systems and methods include a single-photon excitation protocol, which can prevent time dependent light shifts in the clock state and mitigates losses form an intermediate state that are typical in two-photon schemes. In certain embodiments, the excitations laser can have a wavelength of 317 nm. The Rydberg laser 903 can produce 2 Watts of output power frequencies>20 MHz, which is about a factor of 2 larger than known systems. This can allow for a tuning range of the effective transverse field strength in implementations of the Ising model. In certain embodiments, it can also reduce the duration for excitations into the Rydberg state for the creation of Bell states from the ³P₀ state and ensure faster qubit rotations for the realization of phase gates based on the optical qubit (¹S₀-³P₀). Due to a shorter dwell time of the atom in the Rydberg state, the factor of 2 improvement in Rabi coupling can lead to a significant suppression of (exponential) spontaneous decay out of the Rydberg state and further improve gate fidelities.

According to embodiments, an autoionization diode laser 904 operating at a wavelength of 407.6 nm and an output power of >10 mW can be used to autoionize Sr atoms in the Rydberg state by addressing the ₂S1/₂-₂P3/₂ of the Sr+ ionic core. The laser can be locked to an existing wavemeter (HighFinesse WS-7) through an 8-channel galvo-based multiplexer. Autoionization laser 904 of the disclosed embodiments can detect extremely high-fidelity of Rydberg excitations in the array, as Rydberg atoms can be quickly transferred within 100 nanoseconds to the ion state via excitation on the ₂S1/₂-₂P3/₂ transition of the Sr+ ionic core, which makes Rydberg atoms completely invisible to fluorescence imaging of the ³P₀ state population. This removal scheme for Rydberg atoms is significantly faster than the standard approach which relies on the anti-trapping of Rydberg atoms (in the case of alkalis) and takes on the order of ˜100 μs for the atom to be safely removed. This can be seen by comparing the Bell state fidelities achieved in similar experimental sequences for Cs and Rb arrays (no autoionization), for which fidelities of ˜0.9 and ˜0.95 have been observed, respectively. In contrast, Bell state preparation with Sr arrays (with autoionization) have a fidelity of ˜0.98. An even bigger gain of data quality can be achieved for Ising model quantum simulations with Sr tweezer arrays. Due to the autoionization detection, the number of miscounts of Rydberg excitations can be further reduced

### Lasers and Photonics

According to embodiments, the disclosed system can include holographic atom traps and compact, chip-based laser systems.

According to embodiments of the disclosed subject matter, laser system can include chip-based photonic sources configured to generate all wavelengths with ultranarrow linewidth required for cooling, trapping, exciting, and ionizing of Sr.

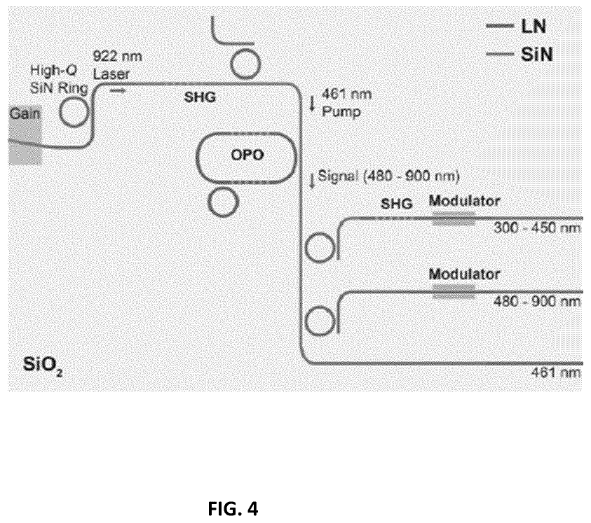

According to embodiments, chip-based photonic sources can include composite silicon nitride (SiN)-lithium niobate (LN) platform, as shown in FIG. 4. The photonic source can utilize the silicon-nitride (SiN) waveguide devices configured to enable record-low losses and enable controlling the flow of light across the entire wavelength range required to operate the disclosed strontium quantum simulator. This design yields precise control over the flow of light across the entire wavelength range essential for the operation of the strontium quantum simulator. Notably, the utilization of SiN waveguides contributes to the creation of an efficient and versatile platform for quantum simulation applications, where maintaining low losses and managing light propagation are critical aspects.

As the pump laser for the frequency conversion chip, a high-power gain-chip can be used with optical gain at 922 nm, integrated with SiN. Illustrated in FIG. 4, the gain-chip is seamlessly integrated with SiN, aligning with the wavelength requirements of the strontium quantum simulator. The design considerations enhance the precision and adaptability of the quantum simulator system, catering to diverse experimental needs. In certain embodiments, laser design can be based on ultra-high-Q microresonators that offers the potential for linewidths as low as 10 Hz and significant tunability. Parametric χ⁽²⁾ gain can be integrated via integration of a lithiumniobate (LN) thin film onto SiN such that etching of the LN is not required. Notably, this integration is designed to eliminate the need for etching the LN, streamlining the manufacturing process and preserving the structural integrity of the composite platform. The χ⁽²⁾ gain mechanism enhances the efficiency of frequency conversion within the chip, contributing to the overall performance of the quantum simulator.

According to embodiments, the system can include microresonators for performance of highly efficient second harmonic generation (SHG) and optical parametric oscillation. Phase matching can be achieved via periodic poling or via coupling to higher-order spatial modes to produce single frequency operation across the entire required wavelength range, in particular laser light at 461 nm.

In certain embodiments, both quantum-noise-limited and thermorefractive-noise-limited operations can be used to achieve a Schawlow-Townes linewidth of 1 Hz by an OPO with a Q of 1×10⁶ and output power of 20 mW.

According to embodiments, integrated chip-based laser sources can be used to generate the laser light for laser cooling and trapping atoms. The laser light can be generated on silicon-based nanophotonic chips, which can greatly simplify typical methods for generating laser lights.

According to embodiments, chip-based laser sources can produce >10 mW of laser power at 679, 689, 698, and 707 nm, all with <1 MHz linewidth. In certain embodiments, for cooling and trapping of Sr, chip-based sources can produce >20 mW of laser power, all with <100 kHz linewidth, except for 689 nm (<10 kHz) and 698 nm (<10 Hz). In addition, the sources are tunable sources in the blue at 317 nm (>40 mW), 407 nm (>20 mW), 461 nm (>200 mW) and 520 nm (>20 mW), all with linewidth <1 MHz.

According to embodiments, the photonics can include phase-amplitude metasurface holograms to generate both periodic and arbitrary (aperiodic) optical tweezer arrays for cold atom trapping. A phase-amplitude metasurface hologram provides 2D modulation of the complex wavefront of the incident plane wave with subwavelength spatial resolution; thus, the hologram can produce a complex optical field where each point has an arbitrarily controllable combination of optical phase and amplitude.

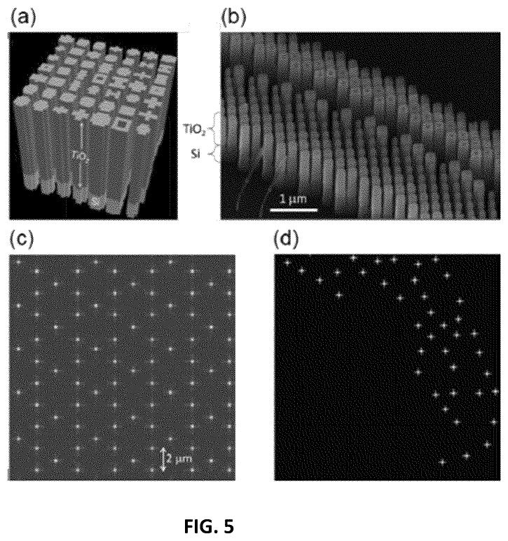

In certain embodiments, as shown in FIG. 5A-5B, the metasurfaces can be composed of monolithic bilayer meta-atoms consisting of a thick top layer of TiO₂, for phase modulation, and a thin bottom layer of Si, for amplitude modulation. Metasurfaces of TiO₂ can offer precision control over the phase of an optical wavefront. Metasurface according to disclosed embodiments can be extremely resilient against high laser intensity and can withstand >1000 W/cm², which is significantly above the damage threshold of AODs and liquid crystal SLMs. In certain embodiments, around 60% of the incident optical power can be turned into the desired array pattern, which is significantly more than for AODs (around 50%) and SLMs (around 40%).

The meta-atom geometry can be engineered and configured such that visible light passing through the meta-atoms acquire various degrees of attenuation and phase delay. For example, the disclosed system can create Kagome lattices with percent-level intensity uniformity at a trap spacing of 2 μm (as shown in FIG. 5C). The disclosed system can create arbitrary tweezer arrays emulating a map with the locations of the 1725 largest US cities as of the time of filing (as shown in FIG. 5D). Such “graphs” of cold atoms can help solve “maximum independent set” problems.

In certain embodiments, the platform can include 1,000-10,000 trapped atoms, which can enable more complex quantum systems than classical simulation.

According to embodiments, the optical tweezer array can include a sub-micrometer spacings, dynamical control over atomic positions and local addressability, ensuring high connectivity of the atom array and flexible selectivity of atom pairs for two-qubit gates.

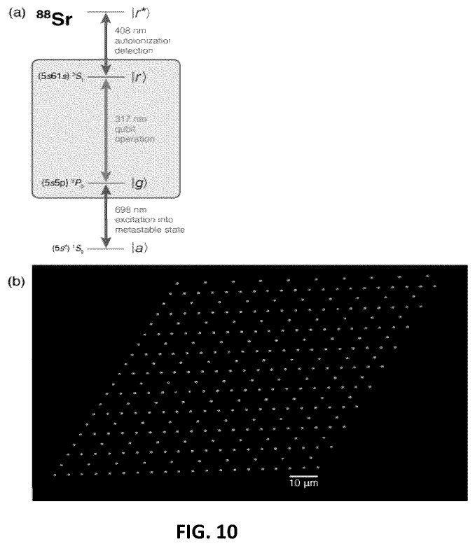

According to embodiments, the disclosed metasurface holograms can generate periodic and aperiodic trap arrays with >1,000 optical traps and <2 μm spacing between neighboring traps at visible wavelengths. In certain embodiments, planar SLMs can be based on adiabatic micro-ring phase shifters with 512 channels and frame rate >200 kHz. The improved power handling of metasurface-based arrays according to disclosed embodiments compared to standard approaches (AOD, SLM, see above) makes it possible to perform Ising quantum simulations in even larger arrays. Based on the power handling of the metasurfaces, a arrays can be scaled to more than 10,000 traps. Another advantage of metasurfaces is to create trapping arrays in arbitrary shapes with extremely high intensity- and position-uniformity. FIG. 10B shows a large Kagome lattice array generated using disclosed embodiments. However, additional complex trapping arrangements in 2D (such as a Penrose quasicrystal) and in 3 (such as a trilayer simple cubic lattice and a twisted bilayer graphene structure) are also possible.

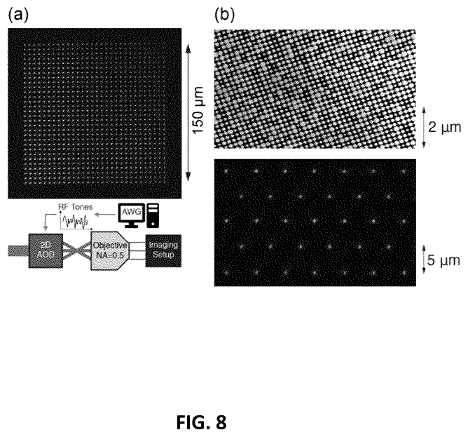

In certain embodiments, as a risk management strategy, an atom sorting system based on a crossed-AOD setup (as used in the 30×30 tweezer array in FIG. 2, inset) can be implemented. The AODs can be supplied with up to 30 radio-frequency (RF) tones spaced by about 1 MHz in frequency and with randomized phases to suppress intermodulation, as can be seen in FIG. 8A. The RF tones can be dynamically changed to switch off unoccupied traps and consolidate an atomic array to reach unity filling. Crossed AODs can be used to dynamically control an individual laser beam for atom sorting. As can be seen in FIG. 8, the traps can be generated at 520 nm, the magic wavelength for the Sr intercombination line.

According to embodiments, the system can include broadband, polarization insensitive flat-lens, phase-amplitude meta-holograms, and resonant, wavefront-shaping metasurfaces. In certain embodiments, compact, efficient integrated phase modulators at visible wavelengths can be included.

According to embodiments, analog quantum simulation can be realized in dimerized, triangular and Kagome lattices or disordered potentials; for digital quantum computing with isolated Rydberg atoms, the trapping geometry can be optimized to reduce cross-talk between local spins to achieve high fidelity gate operations. The system can feature a high-resolution imaging system with local addressability for readout and manipulation. The high-speed dynamical reconfiguration enabled by the holographic SLM can allow the initialization of arrays with perfect filling. In certain embodiments, the system will enable measurement of the many-body wavefunction, as well as spin-spin correlations.

In certain embodiments, the generated laser light can be delivered to the atomic gases or the holographic SLM via fibers and phased-array outcouplers to control the direction and focus laser beams.

According to embodiments, repeated readout (using fluorescence imaging on the 461 nm transition plus repumpers) can be performed of the ⁸⁸Sr tweezer array without the need to reload atoms. Non-destructive imaging can substantially increase the data rate of the setup for quantum simulation and computing applications. The repeated readout will be helpful to reduce Dick noise for operation of the setup as a tweezer clock. For trapping of ⁸⁸Sr at 813 nm, a readout fidelity of the clock state of >0.9999 can be reached, which can enable repeated imaging of up to 2000-times. To do so, Sisyphus cooling on the intercombination line during imaging can be performed. For tweezers at 497 nm, Sisyphus cooling with a single 689 nm beam can be used as the excited state ³P₁ is significantly more tightly trapped than 1S₀.

### Timing and Control

According to embodiments of the disclosed subject matter, the system can include a timing system with nanosecond-resolution. An important aspect of the design criteria for the disclosed subject matter is timing resolution and accuracy of 1 ns, which is typically cannot be achieved by commercially available systems. Having this timing resolution and accuracy is important for atomic manipulations and gate operations with unprecedented precision.

According to embodiments, to achieve this, the system includes a timing and control 103 box (utilizing a Xilinx FPGA) that receives commands from a control PC and communicates with decentralized input/output (IO) crates via duplex LC optical fiber links. The IO crates feature a Xilinx Ultrascale+ FPGA that sits on a backplane and distributes signals to 10 custom-designed IO cards per crate. The system can support >100 digital control channels and >50 analog channels.

In certain embodiments, a high-speed camera read-out system based on a Versal AI Core FPGA board and interface with a low-noise EMCCD camera for fast state-detection of individual atoms can be used. The hardware-based read-out can allow measurement-based updates to the experimental sequence, providing new paradigms for analog and digital quantum algorithms.

### User Interface & Quantum Compiler

According to embodiments, the software architecture for securely hosting the public-facing user interface (UI) of the atomic quantum simulator is designed to be secure and cloud-based. Software can include the web presence, the public landing page, several specific UIs, and compilers for the different modes of operation of the hardware disclosed above.

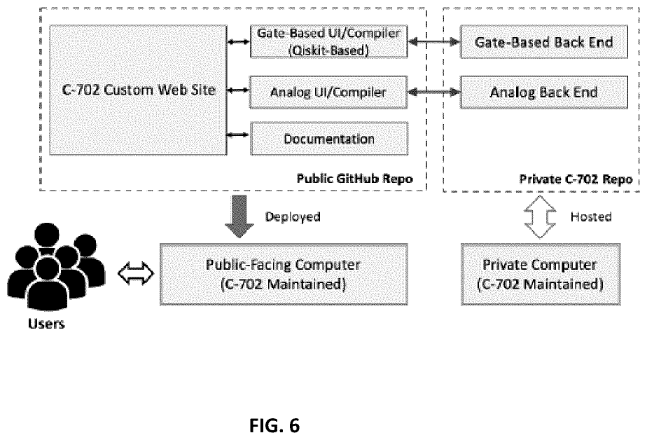

In certain embodiments, as shown in FIG. 6, the user interface can include three modes: (1) digital gate-based, (2) general quantum Ising models, and (3) maximum-independent set problem.

In certain embodiments, the software can include queuing infrastructure to allow multiple user requests to the quantum processor hardware and a logging and data-archiving infrastructure to promote single-user and collaborative productivity. The UI can have an all-graphics mode and accept and return text-based input/output. This functionality can enable and support extensible user-facing programming language. For example, UI can be configured to ensure multiple types of users (e.g., general public, students, researchers, etc.) have the software tools needed to interact with the quantum hardware productively.

In certain embodiments, the software components can be hosted on a virtual server, to enable virtual access to the platform. Non-limiting examples of virtual server include Google Cloud Platform (GCP).

According to embodiments, the software can adapt and extend the IBM Qiskit package towards neutral atom platforms. For example, the Qiskit transpiler can be adapted to the disclosed neutral atom platform. The Qiskit transpiler translates high-level quantum circuits into commands usable by the hardware system. As a result, the system can support multiqubit gates (which are native to the disclosed platform) and enable new approaches for dynamical decoupling (during gate operations), allowing the disclosed system to carry out digital quantum calculations with larger circuit depth.

In certain embodiments, the user interface can include a powerful classical solver for quadratic unconstrained binary optimization (QUBO) problems. This can allow seamless execution of quantum-classical algorithms, such as QAOA (quantum approximate optimization algorithms), on our platform. Computational methods to solve QUBO models play an important role in quantum annealing and adiabatic computing.

According to embodiments, the timing system can translate user commands into radiofrequency and optical pulses to manipulate the atomic array.

### Quantum Applications & Algorithms

According to embodiments, the system can provide quantum advantage for materials research, chemistry, logistics, and finance calculations. In certain embodiments, application of the disclosed subject matter can include: (1) Graph-based optimization problems implemented with Rydberg atoms with reduced or minimal overhead; (2) Hybrid digital-analog quantum computation for more efficient variational quantum algorithms (VQE); (3) Dynamics of complex quantum systems utilizing mid-circuit measurements; (4) Applications exploiting multi-qubit entangling gates (e.g. Toffoli), such as non-Abelian topological error-correcting codes; (5) Applications benefitting from large qubit systems, such as quantum chemistry and error benchmarking.

According to embodiments, the disclosed subject matter can be used to simulate complex matters by implementing Hubbard models, Ising and XY models, all of which can benefit from the favorable properties of Rydberg excitations in strontium.

In certain embodiments, quantum chemistry simulations can be implemented to determine ground state energies of molecules and reaction complexes.

In certain embodiments, the potential for quantum speedup for optimization algorithms with relevance in network problems and finance (e.g., Maximum Independent Set) can be investigated.

In certain embodiments, algorithms can be designed to take advantage of the hybrid analog-digital architecture of the proposed quantum simulation platform and the larger number of qubits compared to digital-only devices. One broad class of algorithms that would benefit from this is variational quantum algorithms (VQAs). The disclosed subject matter can be useful in identifying “analog-digital” parameterized ansatzes optimized in a VQA. In certain embodiments, the disclosed subject matter can develop theoretical foundations of simulations performed on hybrid analog-digital devices.

### Quantum Uses

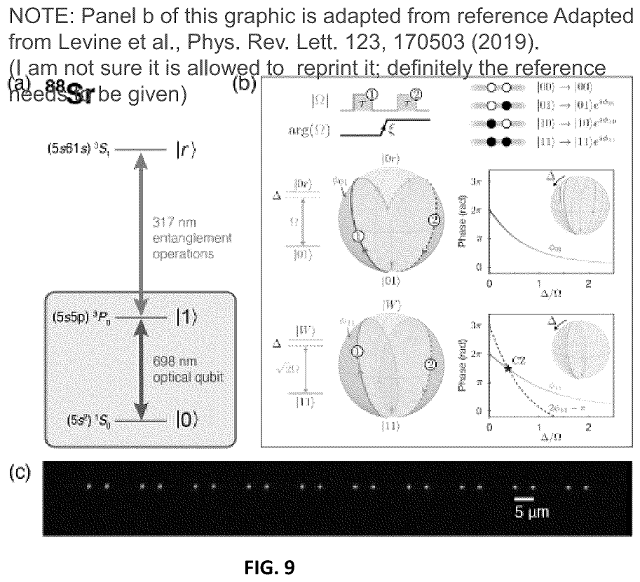

The disclosed subject matter has quantum applications. For example, the disclosed subject matter can be used for optical qubit and gate control. The ¹S₀-³P₀ clock transition in strontium can serve as a powerful qubit for the use of strontium tweezer arrays in quantum computing applications, as can be seen in FIG. 9A-9C. FIG. 9A-9C depicts the implementation of a high-fidelity phase gate using ⁸⁸Sr, focusing on several components and interactions.

As illustrated in FIG. 9A of a relevant level diagram displaying the key energy states involved in the quantum processes, the optical clock transition can serve as a long-lived qubit state, with interactions mediated through transitions involving the Rydberg state. FIG. 9B depicts an operation of a phase-gate scheme based on the states of neighboring atoms, specifically whether they are in the |01 [symbol] /|10 [symbol] or the |11 [symbol] state, where is adapted from Levine et al., Phys. Rev. Lett. 123, 170503 (2019). Different phases are acquired based on these conditions. This scheme outlines the methodology for inducing phase gates within the quantum system. FIG. 9C illustrates a diagram of array of dimerized traps. The array of dimerized traps is generated using a holographic metasurface generated by the disclosed subject matter. Similar arrays can also be created using the acousto-optic deflector (AOD) approach. These traps play a role in enabling quantum state rotations on the optical qubit (¹S₀-³P₀), entangling qubits via the Rydberg blockade mechanism, and enhancing the fidelity of Rydberg state detection. The traps are instrumental in reliable state detection in quantum simulations, particularly for the Ising model.

According to embodiments of the disclosed subject matter, single qubit rotations can be performed across the atomic array with high fidelity. Additionally, two-qubit gate operations can be achieved via the use of the Rydberg state.

In certain embodiments a fidelity boost to 0.999 would be a substantial improvement and make ⁸⁸Sr an important competitor as a quantum computation platform. For example, FIG. 9C shows a dimerized tweezer array generated by a holographic metasurface, in which an implementation of this gate scheme could be implemented. According to embodiments, gate operations between could be performed not only between neighboring atoms, but also between distant atoms. To this end, the narrow clock transition can be exploited. For example, by locally addressing sites with the 520 nm sorting laser beam, resonance individual atoms can be tuned into- and out-of-resonance. As such, atoms can be selectively activated to participate in the gate scheme. In certain embodiments, the optical qubit can allow exploration of entanglement schemes to enhance optical clock performance.

According to embodiments, the disclosed subject matter can be used for creation and observation of complex spin order. For example, reliable initialization of the Sr tweezer array in the metastable ³P₀ state can be used to perform high fidelity studies of Ising spin physics, as shown in FIG. 10A-10B, e.g., in alkaline-earth tweezer arrays.

According to embodiments, the disclosed subject matter can be used for quantum optimization problems. For example, the strontium tweezer platform can be used to implement relevant optimization problems on graphs. Such problems can include the Maximum-Independent Set problem (MIS). MIS problem in its unit-disk formulation can be natively implemented on Rydberg tweezer platforms because the MIS problem can be formulated in terms of a cost function that takes the shape of the Ising Hamiltonian. As interactions between Rydberg atoms have a finite-range due to the Rydberg blockade, this particularly corresponds to the unit disk MIS problem. The MIS problem is an application case, where the atomic tweezer platform can demonstrate quantum advantage due to the efficient native implementation and despite the fact that the platform operates in the NIQS regime. Graph problems that have real-world relevance and can be formulated in the form of an MIS problem include the optimal deployment of radiofrequency antennas to achieve improved or optimal 5G coverage or the optimal locations for charging stations for electric vehicles. Similarly, DoD relevant applications, such as the optimal deployment of defense infrastructure, can be formulated in this way.

The disclosed subject matter is not to be limited in scope by the specific embodiments described herein. Indeed, various modifications of the disclosure in addition to those described herein will become apparent to those skilled in the art from the foregoing description and the accompanying figures. Such modifications are intended to fall within the scope of the appended claims.

What we claim is:

1. A quantum simulator, comprising:
an atomic platform configured to provide a source of atoms;
a laser and photonics system configured to cool and trap the atoms;
a timing and control box;
a user interface configured to control the atomic platform and the laser and photonics system; and
quantum algorithms.

2. The simulator of claim 1, wherein the atomic platform includes one or more atomic sources, a vacuum chamber, and an imagining system.

3. The simulator of claim 2, wherein the atomic source includes a high-flux source for strontium atoms.

4. The simulator of claim 3, wherein the strontium atoms are ⁸⁸Sr or ⁸⁷Sr.

5. The simulator of claim 3, wherein the atoms in the atomic source have an atomic flux greater than >10⁹ atoms/second.

6. The simulator of claim 1, wherein the vacuum chamber includes a glass cell with wide optical access.

7. The simulator of claim 1, wherein the laser and photonics system comprises a holographic metasurface configured to generate an optical tweezer array from the one or more incident laser beam.

8. The simulator of claim 7, wherein the optical tweezer array is two-dimensional.

9. The simulator of claim 2, wherein the vacuum chamber includes a two-stage magneto-optical trap (“MOT”).

10. The simulator of claim 9, wherein a first stage of the MOT includes a blue 2D MOT having a wavelength of 461 nanometers.

11. The simulator of claim 10, wherein a second stage of the MOT includes a narrow-line MOT having a wavelength of 689 nanometers.

12. The simulator of claim 1, further comprising chip-based photonic sources.

13. The simulator of claim 12, wherein the chip-based photonic sources comprises composite silicon nitride (SiN)-lithium niobate (LN) platform.

14. The simulator of claim 1, wherein the atomic platform is configured to collect atoms in an array of traps.

15. The simulator of claim 1, wherein the array of traps is generated by a holographic metasurface.

16. The simulator of claim 1, wherein the laser and photonic system is configured to initialize atoms to a metastable state.

17. The simulator of claim 1, wherein the timing and control box comprises a timing system with nanosecond-resolution.

18. The simulator of claim 1, wherein the user interface is configured to allow a user to interact with and control the simulator.

19. The simulator of claim 1, wherein the user interface is configured to allow a user to input the quantum algorithms.

20. The simulator of claim 1, further comprises an integrated holographic spatial light modulator (SLM) configured to consume low power to optically manipulate cold atoms.
